(19) United States
(12) Patent Application Publication
(10) Pub. No.: US 2005/0177492 A1
(43) Pub. Date: Aug. 11, 2005

(54) Apparatus and method for asset tracking and recovery

(76) Inventor: Walt Camping, Phoenix, AZ (US)

Correspondence Address: Wright Law Group, PLLC, Suite 2, 7201 West Oakland, Chandler, AZ, 85226, US

(21) Appl. No.: 11/105,813

(22) Filed: Apr. 13, 2005

Related U.S. Application Data
(63) Continuation-in-part of application No. 10/209,669, filed on Aug. 1, 2002.

(51) Int. Cl. G06F 17/60

(52) U.S. Cl. 705/38

(57) ABSTRACT

The apparatus and methods of the present invention provide for the monitoring and tracking of various items such as vehicles that may be used as collateral to secure a loan or lease. The present invention thereby provides for the efficient and effective recovery of collateral by a lien holder in the case of default on the loan or lease. The most preferred embodiments of the present invention include a computer-based system for monitoring the location and status of collateral while the collateral is in the purchaser's possession. The historical information related to the location and/or condition of the collateral is periodically stored in a database that is accessible via a global computer network such as the Internet. If and when it becomes necessary to repossess the collateral, the information stored in the database can be accessed to provide various types of information that may aid in the recovery of the collateral.

### RELATED APPLICATION

This application is a continuation in part of U.S. patent application Ser. No. 10/209,669, filed Aug. 1, 2002, which application is now pending at the United States Patent and Trademark Office, which application is incorporated herein by reference.

### FIELD OF INVENTION

The present invention relates generally to the field of computerized databases and more particularly to the use of computer-based systems and methods for tracking and recovering collateral such as motor vehicles and the like.

### BACKGROUND ART

In the collateral recovery business, a person will typically purchase an item of personal property, such as an automobile, motorcycle, boat, etc. and finance their purchase over time. In these cases, the lender will generally place a lien on the personal property and the personal property becomes a form of collateral to secure the loan. The lien holder also reserves the right to repossess the collateral if the purchaser fails to make the required payments or otherwise defaults on their obligation with respect to the collateral. In the case of default, it may be necessary for the lien holder to repossess the collateral in order to secure their interest in the collateral. In these cases, the lien holder will typically engage the services of a third party repossession agent and contract with the third party repossession agent to complete the recovery.

While the process described above is a frequently employed methodology for collateral recovery, it is not without certain drawbacks. For example, if the purchaser decides to no longer make the required payments to the lien holder, locating the collateral may become rather difficult for the lien holder. This is because the purchaser may decide to move the collateral to a location unknown to the lien holder and, refuse to provide information regarding the location of the collateral. In this case, the lien holder may employ an investigative service agency or other means in their attempt to locate and recover the collateral. This problem is especially prevalent in industries such as the automobile and boat rentals and sales. In the realm of high value mobile assets like automobiles, it is very easy for the defaulting purchaser to simply move the automobile to a location other than the purchaser's known residence and thereby frustrate the lien holder's attempts at repossession.

In an attempt to address this problem, certain devices have been designed and deployed to assist the lien holder with collateral recovery. Most of these solutions take the form of an electronic device affixed to the collateral that acts as a “homing” beacon whenever collateral recovery is deemed necessary. If, for example, the automobile is stolen, the electronic homing device can be activated and signal from the homing device can be used by local law enforcement agencies to locate the collateral.

While this methodology can be successful for certain situations, it is presently too expensive to deploy in certain market segments where margins are low and the probability of default for payments is high. Additionally, there is always a chance that the purchaser will remove or disable the tracking device, thereby making the collateral nearly impossible to find without a tedious and time-consuming search effort.

As shown by the discussion herein, without additional improvements in the systems and methods utilized in locating collateral for recovery, collateral repossession results will continue to be sub-optimal.

### SUMMARY OF THE INVENTION

The apparatus and methods of the present invention provide for monitoring, tracking and storing of various types of information about the location and/or status of mobile items such as heavy equipment, farm equipment, and vehicles used as collateral to secure a loan or a lease. The present invention provides for the efficient and effective recovery of collateral by a lien holder, if and when necessary. The information about the items being tracked is collected and transmitted by one or more wireless communication devices such as radios, transceivers, and Global Positioning System (GPS) satellites. The most preferred embodiments of the present invention include a computer-based system for monitoring the location and/or status of collateral while the collateral is in the purchaser's possession. The historical information related to the location and/or status of the collateral is periodically stored in a database that is accessible via a global computer network such as the Internet. If and when it becomes necessary to repossess the collateral, the historical information stored in the database can be accessed to provide various types of information, including predictive location information, that may aid in the recovery of the collateral, if and when necessary.

Additionally, a graphical user interface is provided for inputting, updating, and accessing the information stored in the master database. The interface provides access to a series of web-based reports that allow various entities to access the information stored in the database, within the permission and privacy constraints of the system. This interface provides valuable information that can be used for a variety of purposes. For example, by tracking the location of a vehicle for an extended period of time, a historical record is created. This historical information can be used to project future events that may assist in the collateral recovery process, such as determining the most probable location for the collateral at any given time.

### BRIEF DESCRIPTION OF THE DRAWINGS

The preferred embodiments of the present invention will hereinafter be described in conjunction with the appended wherein like designations denote like elements and:

FIG. 1 is an overall block diagram of a computer-based system for collateral recovery in accordance with a preferred embodiment of the present invention;

FIG. 2 is a block diagram of a computer for implementing the computer-based system for collateral recovery in FIG. 1 in accordance with a preferred embodiment of the present invention; and

FIG. 3 is a flowchart for a method of collateral recovery in accordance with a preferred embodiment of the present invention.

### DETAILED DESCRIPTION

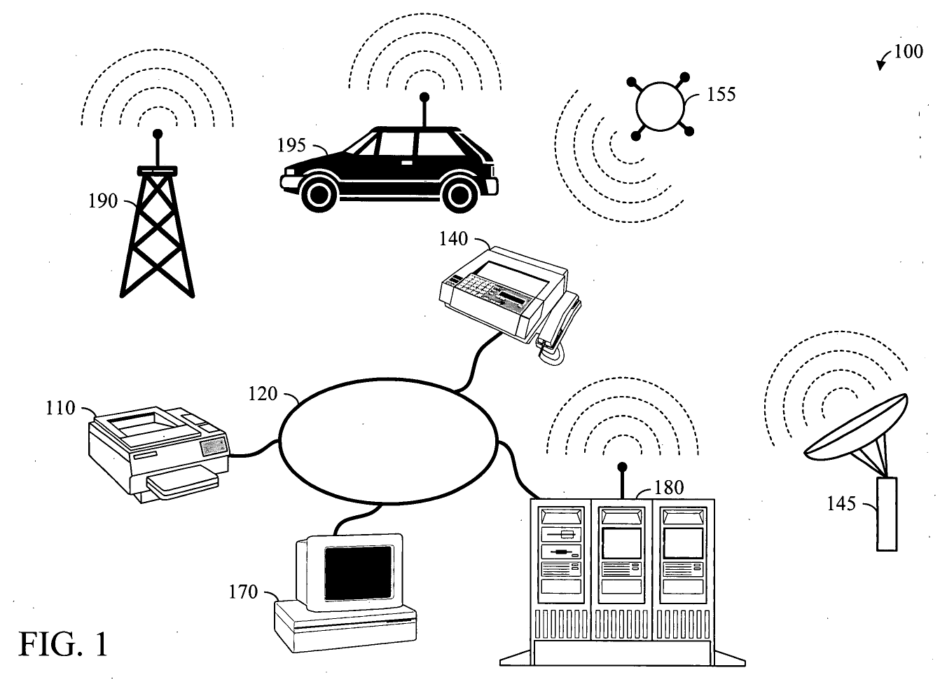

Referring now to FIG. 1, a block diagram of a computer-based system 100 for collateral recovery in accordance with a preferred embodiment of the present invention typically comprises: a satellite transceiver 145; a satellite 155; a computer 170; a data server 180; a communication tower 190; and a vehicle 195, all coupled via a network 120. Additionally, an optional printer 110 and an optional fax machine 140 are shown. Taken together, computer-based system 100 provides a way for car dealers, lien holders (including financial institutions), third party collateral recovery agents and the like to more efficiently and effectively manage the collateral recovery process as described herein in conjunction with the various preferred embodiments of the present invention. Additionally, fleet managers and others may use computer-based system 100 to track and monitor their assets. Accordingly, although the discussion contained herein is focused on collateral applications, those skilled in the art will recognize that.

Optional printer 110 and an optional fax machine 140 are standard peripheral devices that may be used for transmitting or outputting paper-based collateral recovery documents, notes, financial transactions, reports, etc. in conjunction with the collateral recovery related queries and transactions processed by computer-based system 100. Optional printer 110 and optional fax machine 140 may be directly connected to network 120 or indirectly connected via any or all of computer systems 170 and/or data server 180. Finally, it should be noted that optional printer 110 and optional fax machine 140 are merely representative of the many types of peripherals that may be utilized in conjunction with computer-based system 100. It is anticipated that other similar peripheral devices will be deployed in the various preferred embodiment of the present invention and no such device is excluded by its omission in FIG. 1.

Network 120 is any suitable computer communication link or communication mechanism, including a hardwired connection, an internal or external bus, a connection for telephone access via a modem or high-speed T1 line, radio, infrared or other wireless communications, private or proprietary local area networks (LANs) and wide area networks (WANs), as well as standard computer network communications over the Internet or an internal network (e.g. “intranet”) via a wired or wireless connection, or any other suitable connection between computers and computer components known to those skilled in the art, whether currently known or developed in the future. It should be noted that portions of network 120 may suitably include a dial-up phone connection, broadcast cable transmission line, Digital Subscriber Line (DSL), ISDN line, or similar public utility-like access link.

In the most preferred embodiments of the present invention, at least a portion of network 120 comprises a standard wired or wireless Internet connection between the various components of computer-based system 100. Network 120 provides for communication between the various components of computer-based system 100 and allows for relevant information to be transmitted from device to device. In this fashion, a user of computer-based system 100 can quickly and easily gain access to the relevant data and information utilized to enhance the collateral recovery process as described in conjunction with the various preferred embodiments of the present invention. Regardless of physical nature and topology, network 120 serves to logically link the physical components of computer-based system 100 together, regardless of their physical proximity. This is especially important because in the most preferred embodiments of the present invention, data server 180 and computer system 170 will be geographically remote and separated from each other.

Satellite transceiver 145, satellite 155, and communication tower 190 are representative of any wireless communication devices or infrastructure that may be suitably deployed for the various preferred embodiments of the present invention. This includes radio frequency (RF) communication devices and associated communication facilities, wireless broadband access devices, signals and infrastructure, cellular telephones and related communications facilities, etc. Regardless of the actual implementation selected these various wireless communication devices and associated facilities are employed to enable and facilitate communication between the various devices using network 120 and the tracking/reporting device associated with one or more vehicles 195.

Computer system 170 may be any type of computer system known to those skilled in the art that is capable of being configured for use with computer-based system 100 as described herein. This includes laptop computers, desktop computers, tablet computers, pen-based computers and the like. Computer system 170 is most preferably a commercially available computer system such as a Linux-based computer system, IBM compatible computer system, or Macintosh computer system. However, those skilled in the art will appreciate that the methods and apparatus of the present invention apply equally to any computer system, regardless of whether the computer system is a traditional “mainframe” computer, a complicated multi-user computing apparatus or a single user device such as a personal computer or workstation.

Additionally, handheld and palmtop devices are also specifically included within the description of devices that may be deployed as computer system 170. It should be noted that no specific operating system or hardware platform is excluded and it is anticipated that many different hardware and software platforms may be configured to create computer system 170. As previously explained in conjunction with data server 180, various hardware components and software components (not shown this FIG.) known to those skilled in the art may be used in conjunction with computer system 170. It should be noted that in the most preferred embodiments of the present invention, computer system 170 is linked to its own LAN or WAN and has access to its own data server (not shown this FIG.).

Data server 180 represents a relatively powerful computer system that is made available to computer system 170 via network 120. Various hardware components (not shown this FIG.) such as external monitors, keyboards, mice, tablets, hard disk drives, recordable CD-ROM/DVD drives, jukeboxes, fax servers, magnetic tapes, and other devices known to those skilled in the art may be used in conjunction with data server 180. Data server 180 may also be configured with various additional software components (not shown this FIG.) such as database servers, web servers, firewalls, security software, and the like. The use of these various hardware and software components is well known to those skilled in the art. Given the relative advances in the state-of-the-art computer systems available today, it is anticipated that functions of data server 180 may be provided by many standard, readily available data servers. Depending on the desired size and relative power required for data server 180, storage area network (SAN) technology may also be deployed in certain preferred embodiments of the present invention. Additionally, devices for creating and verifying digital signatures (i.e., electronic signature processing) may also be included.

In general, data server 180 processes requests for various transactions for computer system 170. A typical transaction may be represented by a request for information relative to an existing or new collateral recovery transaction or an information request regarding a specific set of circumstances for a new or existing collateral recovery transaction. The requested information may include queries relative to organizations and individuals seeking collateral recovery services as well as reports and other information regarding the actual or proposed collateral recovery transactions.

Additionally, in the most preferred embodiments of the present invention, data server 180 is configured to communicate wirelessly with at least one monitoring/reporting device associated with vehicle 195. In this fashion, data server 180 can receive location and status information relative to vehicle 195. This information is stored in a database configured to maintain the information regarding vehicle 195.

Vehicle 195 represents any type of vehicle that might be used as collateral for a financing arrangement secured by a loan or lease. Each vehicle 195 will be equipped with a monitoring/reporting device that is capable of communicating with the devices of network 120 by utilizing satellite transceiver 145 and/or satellite 155 and/or communication tower 190. In the most preferred embodiments of the present invention, the monitoring/reporting device will be capable of Global Positioning Satellite (GPS) communications as well as cellular telephone network communications.

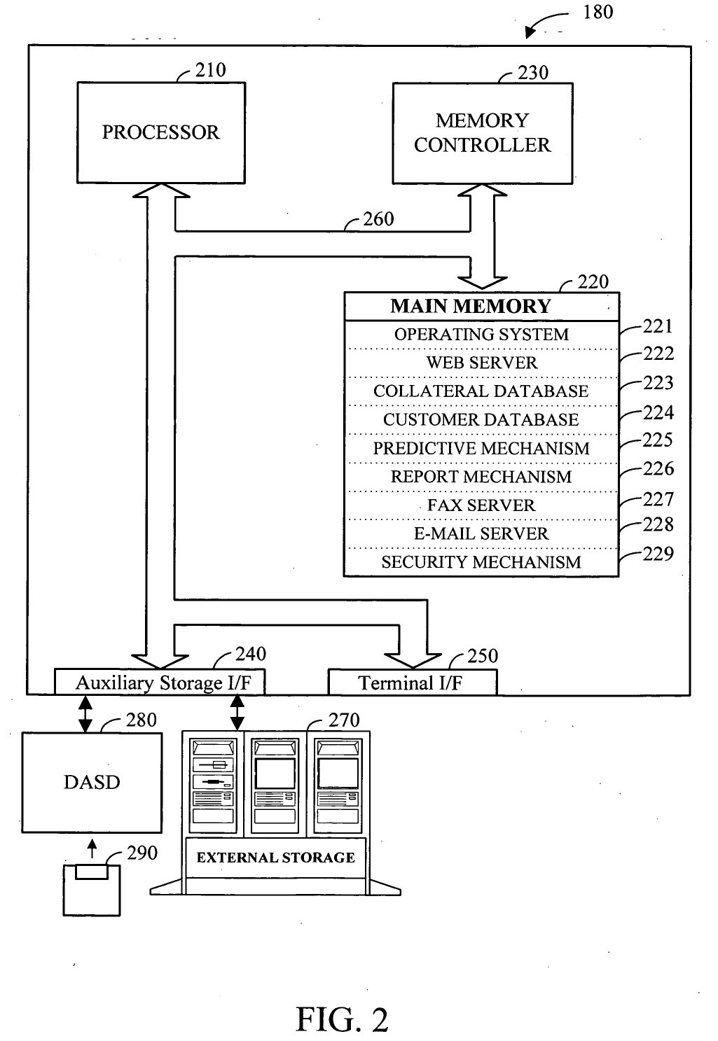

It should be noted that while FIG. 1 shows only a single computer system 170, it is anticipated that the most preferred embodiments of the present invention will comprise hundreds and even thousands of similarly configured computer systems 170 so as to provide access for many different entities. In the most preferred embodiments of the present invention, multiple computer systems 170 will all be configured to communicate with data server 180 and with each other via network 120. In addition, the most preferred embodiments of the present invention include an Application Service Provider (ASP) environment where data server 180 is operated as a clearinghouse in a hosted operation. In this fashion, multiple computer systems 170 will have access to data server 180 on a subscription or pay-for service basis. Data server 180 is further described below in conjunction with FIG. 2 below.

Those skilled in the art will recognize that the depiction of a single satellite transceiver 145, satellite 155 and communication tower 190 are merely representative of standard communication facilities in use today. In reality, multiple satellite transceivers 145, satellites 155 and communication towers 190 will be employed to facilitate “end-to-end” communications within computer-based system 100. Similarly, it is anticipated that many different vehicles 195 (or other types of collateral) will be tracked and monitored by computer-based system 100 in the most preferred embodiments of the present invention. In this fashion, many different lenders and lien holders will be able to receive important information regarding their collateral. Depending on the specific embodiment of the present invention, the user of computer-based system 100 may be the owner of the collateral, the lender, the lien holder. Accordingly, in a similar fashion, fleet managers, farmers, and the owners of heavy equipment will also be able to track and monitor their assets using one or more preferred embodiments of the present invention. Regardless of the role or identity of the user, they will be able to receive the benefits of the present invention to monitor their assets or collateral and, if necessary, recover their assets or collateral in a timely, efficient, and cost-effective manner.

By utilizing the various components of computer-based system 100, a request for collateral recovery information can be made by the user of computer system 170, with the request being received and processed by data server 180. Data server 180 then attempts to contact the monitoring/reporting device associated with vehicle 195 to gather the most current information associated with vehicle 195 (i.e., location, status, etc.). This communication will take place by utilizing network 120 and/or satellite 155 and/or communication tower 190, as necessary.

Once the desired information has been provided by the tracking/reporting device associated with vehicle 195, the information can be communicated to data server 180 and, finally, back to the information requester at computer system 170. In a situation where the monitoring/reporting device associated with vehicle 195 is disabled or otherwise unable to communicate with data server 180, the most recent information and status for vehicle 195 can be reported to the information requester using the data previously stored in data server 180. Additionally, regardless of the status of the tracking/reporting device associated with vehicle 195, predictive information regarding vehicle 195 can be extrapolated from the data previously stored in data server 180. This may include information such as probable locations for vehicle 195 based on historical trends as well as a series of probable times that vehicle 195 will be in a given location. This type of predictive information can be very useful in the collateral recovery process.

Referring now to FIG. 2, a block diagram representing data server 180 of FIG. 1 for implementing the computer-based system for collateral recovery in FIG. 1 in accordance with a preferred embodiment of the present invention is depicted. A data server 180 in accordance with a preferred embodiment of the present invention is most preferably a relatively powerful computer system that is made available to computer system 100 via network 120. Various hardware components (not shown this FIG.) such as external monitors, keyboards, mice, tablets, hard disk drives, recordable CD-ROM/DVD drives, jukeboxes, fax servers, magnetic tapes, and other devices known to those skilled in the art may be used in conjunction with data server 180.

Data server 180 may also be configured with various additional software components (not shown this FIG.) such as database servers, firewalls, security software, and the like. The use of these various hardware and software components is well known to those skilled in the art. Given the relative advances in the state-of-the-art computer systems available today, it is anticipated that functions of data server 180 may be provided by many standard, readily available data servers. Depending on the desired size and relative power required for data server 180, storage area network (SAN) technology may also be deployed in certain preferred embodiments of the present invention. Additionally, devices for creating and verifying digital signatures (i.e., electronic signature processing) may also be included.

Data server 180 suitably comprises at least one Central Processing Unit (CPU) or processor 210, a main memory 220, a memory controller 230, an auxiliary storage interface 240, and a terminal interface 250, all of which are interconnected via a system bus 260. Note that various modifications, additions, or deletions may be made to data server 180 illustrated in FIG. 2 within the scope of the present invention such as the addition of cache memory or other peripheral devices. FIG. 2 is not intended to be an exhaustive example, but is presented to simply illustrate some of the salient features of data server 180.

Processor 210 performs computation and control functions of data server 180, and comprises a suitable central processing unit (CPU). Processor 210 may comprise a single integrated circuit, such as a microprocessor, or may comprise any suitable number of integrated circuit devices and/or circuit boards working in cooperation to accomplish the functions of a processor. Processor 210 suitably executes one or more software programs contained within main memory 220.

Auxiliary storage interface 240 allows data server 180 to store and retrieve information from auxiliary storage devices, such as external storage mechanism 270, magnetic disk drives (e.g., hard disks or floppy diskettes) or optical storage devices (e.g., CD-ROM). One such suitable storage device is a direct access storage device (DASD) 280. As shown in FIG. 2, DASD 280 may be a floppy disk drive that may read programs and data from a floppy disk 290. It is important to note that while the present invention has been (and will continue to be) described in the context of a fully functional computer system, those skilled in the art will appreciate that the mechanisms (particularly predictive mechanism 225 and/or report mechanism 226 of FIG. 2) of the present invention are capable of being distributed in conjunction with signal bearing media as one or more program products in a variety of forms, and that the various preferred embodiments of the present invention applies equally regardless of the particular type or location of signal bearing media used to actually carry out the distribution. The term “signal bearing media” as used herein refers to any medium that participates in providing data (e.g., instructions) which may be read by a computer, a processor or similar device.

Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may also include or convey acoustic waves, light waves and electromagnetic emissions, such as those generated during radio frequency (RF) and infrared (IR) data communications.

Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. Specific examples of signal bearing media include: recordable type media such as floppy disks (e.g., disk 290) and CD ROMS, and transmission type media such as digital and analog communication links, including wireless communication links.

Memory controller 230, through use of an auxiliary processor (not shown) separate from processor 210, is responsible for moving requested information from main memory 220 and/or through auxiliary storage interface 240 to processor 210. While for the purposes of explanation, memory controller 230 is shown as a separate entity; those skilled in the art understand that, in practice, portions of the function provided by memory controller 230 may actually reside in the circuitry associated with processor 210, main memory 220, and/or auxiliary storage interface 240.

Terminal interface 250 allows users, system administrators and computer programmers to communicate with data server 180, normally through separate workstations or through stand-alone computer systems such as computer systems 170 of FIG. 1. Although data server 180 depicted in FIG. 2 contains only a single main processor 210 and a single system bus 260, it should be understood that the present invention applies equally to computer systems having multiple processors and multiple system buses. Similarly, although the system bus 260 of the preferred embodiment is a typical hardwired, multi-drop bus, any connection means that supports bi-directional communication in a computer-related environment could be used.

Main memory 220 suitably contains an operating system 221, a web server 222, collateral database 223, a customer database 224, a predictive mechanism 225, a report mechanism 226, a fax server 227, an e-mail server 228, and a security mechanism 229. The term “memory” as used herein refers to any storage location in the virtual memory space of data server 180.

It should be understood that main memory 220 may not necessarily contain all parts of all components shown. For example, portions of operating system 221 may be loaded into an instruction cache (not shown) for processor 210 to execute, while other files may well be stored on magnetic or optical disk storage devices (not shown). In addition, although collateral database 223, customer database 224, predictive mechanism 225, and report mechanism 226 are shown to reside in the same memory location as operating system 221, it is to be understood that main memory 220 may consist of multiple disparate memory locations. It should also be noted that any and all of the individual components shown in main memory 220 may be combined in various forms and distributed as a stand-alone program product. Finally, it should be noted that additional components, not shown in this figure may also be included.

For example, while not required, most preferred embodiments of the present invention will include a security and/or encryption mechanism 229 for verifying access to the data and information contained in and transmitted by data server 180. Security and/or encryption mechanism 229 may be incorporated into operating system 221 or predictive mechanism 225. Additionally, security mechanism 229 may also provide encryption capabilities for computer-based system 100 of FIG. 1, thereby enhancing the robustness of computer-based system 100. Once again, depending on the type and quantity of information stored in collateral database 223 and customer database 224, security mechanism 229 may provide different levels of security and/or encryption for different computer systems 170 and data server 180. Additionally, the level and type of security measures applied by the security system may be determined by the nature of a given request and/or response, including the identity of the requestor. In some preferred embodiments of the present invention, security mechanism 229 may be contained in or implemented in conjunction with certain hardware components (not shown this FIG.) such as hardware-based firewalls, routers, switches, dongles, and the like.

Operating system 221 includes the software that is used to operate and control data server 180. In general, processor 210 typically executes operating system 221. Operating system 221 may be a single program or, alternatively, a collection of multiple programs that act in concert to perform the functions of an operating system. Any operating system known to those skilled in the art may be considered for inclusion with the various preferred embodiments of the present invention.

Web server 222 may be any web server application currently known or later developed for communicating with web clients over a network such as the Internet. Examples of suitable web servers 222 include Apache web servers, Linux web servers, and the like. Additionally, other vendors have developed or will develop web servers that will be suitable for use with the various preferred embodiments of the present invention. Finally, while depicted as a single device, in certain preferred embodiments of the present invention web server 222 may be implemented as a cluster of multiple web servers, with separate hardware and software systems being connected with load balancers and the like. This configuration provides additional robustness for system uptime and reliability purposes. Regardless of the specific form of implementation, Web server 222 typically provides access, including a user interface, to allow individuals and entities to interact with predictive mechanism 225 and report mechanism 226, including via network 120 of FIG. 1.

Collateral database 223 and customer database 224 are representative of any suitable database known to those skilled in the art. In the most preferred embodiments of the present invention, collateral database 223 and customer database 224 are most preferably Structured Query Language (SQL) compatible database files capable of storing information relative to the various types of collateral sold or leased by the lien holders. Additionally, various collateral recovery programs, fees, costs, rates, third party repossession agencies or entities, including names, addresses, account preferences, etc. may be maintained by collateral database 223. While collateral database 223 and customer database 224 are shown residing in main memory 220, it should be noted that collateral database 223 and customer database 224 may also be physically stored in a location other than main memory 220. For example, collateral database 223 and customer database 224 may be stored on external storage device 270 or DASD 280 and coupled to data server 180 via auxiliary storage I/F 240.

Collateral database 223 is typically used to store information about the specific collateral to be recovered. For example, in the case of automobile recovery, collateral database 223 would include information such as vehicle make, model, year, VIN, owner, known addresses associated with the collateral, etc. Additionally, collateral database 223 is used to monitor and update the status and location of any collateral identified in collateral database 223.

Customer database 224 is typically used to store information about various customers (or users) that use system 100 of FIG. 1 to request information in conjunction with providing and/or receiving collateral recovery services. This would include information about the various lenders, lien holders, third party recovery agents, etc.

Predictive mechanism 225 is most preferably a web-based software application that provides a graphical user interface for requesting, monitoring, updating and reporting on status and location of the collateral identified in collateral database 223. In the most preferred embodiments of the present invention, a user of computer system 170 of FIG. 1 will access predictive mechanism 225 via a standard web browser such as Safari, FireFox, Netscape, Internet Explorer, etc. By using predictive mechanism 225, the user will be able to request collateral recovery information, such as past or current location of the collateral (including the time the collateral was at any given location), probable future location of the collateral, etc. This information is generated by predictive mechanism 225 based upon the collateral-related data previously stored in collateral database 223. Predictive mechanism 225 will serve as the interface to database 223 and customer database 224 and will store, update and retrieve information in collateral database 223 and customer database 224. It is anticipated that various reports related to the collateral described in collateral database 223 will be generated by report mechanism 226, thereby enhancing the probability of collateral recovery.

Report mechanism 226 is provided to allow a user of system 100 of FIG. 1 to create a variety of reports by accessing collateral database 223 and customer database 224. These reports will include status reports that highlight the status of the collateral, the condition of the collateral, the past and present location of the collateral, etc. Those skilled in the art will recognize that the number and variety of reports that can be created and provided by report mechanism 226 is virtually unlimited and will be determined by the type and amount of data stored in collateral database 223 and customer database 224.

Those skilled in the art will recognize that although predictive mechanism 225 and report mechanism 226 are shown as separate entities in FIG. 2, predictive mechanism 225 and report mechanism 226 may be combined into a single software program or application or program product. Additionally, collateral database 223 and customer database 224 may also be included in this software program or application.

Fax server 227 is any fax server known to those skilled in the art and is configured to receive inbound fax messages and to transmit outbound fax messages. Fax server 227 may format and transmit any data processed by computer-based system 100 of FIG. 1 and make it available for use by any other component of computer-based system 100 of FIG. 1. Additionally, fax server 227 may process the data received and send it directly to predictive mechanism 225 and make the incoming data available for further processing by computer-based system 100, including processing by report mechanism 226.

While not required, the most preferred embodiments of data server 180 of FIG. 2 will typically include an e-mail server 228. E-mail server 228 is any e-mail server application capable of being configured and used to send and receive various status messages and updates to data server 180 and/or computer 170 of FIG. 1 via e-mail, as may be necessary to enhance the overall process of completing various collateral recovery activities described herein. This includes the generation of automated e-mail messages relating to the status of collateral described in accordance with the various preferred embodiments of the present invention.

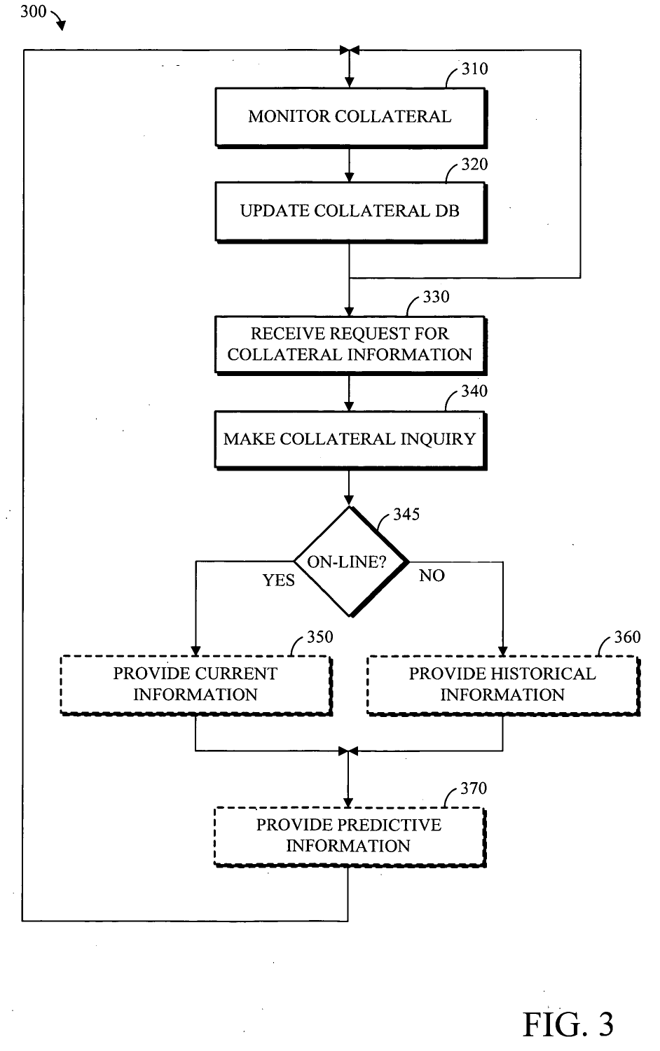

Referring now to FIG. 3, a flowchart for a method 300 for utilizing computer-based system 100 of FIG. 1 in the collateral recovery process in accordance with a preferred embodiment of the present invention is depicted. As shown in FIG. 3, method 300 begins with the monitoring of the collateral (step 310). MONITOR EVERY 15 MINUTES AND STORE DATA IN DATABASE The collateral monitoring is most preferably performed by a monitoring/reporting device affixed to or otherwise associated with the collateral. In general, the monitoring/reporting device is a combination GPS and cellular signal electronic module that is capable of monitoring and reporting the location of the collateral and any associated status of the collateral. The monitoring/reporting device will gather time, location and status-related information and then periodically transmit that information to data server 180 of FIG. 1 as previously described. In the most preferred embodiments of the present invention the interval or frequency for reporting the information to data server 180 may be user-selectable, based on the specific application. For most applications, it is anticipated that the information will be transmitted approximately four times an hour or about every 15 minutes. Those skilled in the art will recognize that other reporting intervals may be advantageously adopted in other application environments without departing from the spirit and scope of the present invention.

As shown in FIG. 3, the location and status information for the collateral is stored in a collateral database (DB) (step 320). In the case of a typical vehicle monitoring situation, this information would include such data as vehicle location, vehicle status, etc. Additionally, it should be noted that in addition to the periodically reported information, the collateral database will also include additional information related to the collateral that is not necessarily updated during the monitoring process. The additional information will typically include items such as the lien holder name and address, the purchaser's name and address, the description of the collateral (for an automobile recovery, this would include make, model, VIN, etc.), and other similar types of information that may be useful in the collateral recovery process. As suggested in FIG. 3, the information related to the collateral is updated on a periodic basis. The schedule or frequency of updates will be configured by the operator of system 100 as desired for a given application.

At some point, a request for collateral information will be received (step 330). A collateral information request will usually be the result of a lack of payment and associated with a lien holder's desire to repossess the associated collateral. Upon receiving the request for information, system 100 of FIG. 1 will attempt to contact and query the monitoring/reporting device associated with the collateral (step 340) to retrieve the latest location and/or status information. If the monitoring/reporting device is on-line and information regarding the present location of the collateral is available (step 345=“YES”), the most recent information (including any relevant information from data server 180 of FIG. 1) will be provided to the user that requested the information, whether that is the computer operator, lien holder, lender, dealer, etc. (step 350). In the most preferred embodiments of the present invention, a commercial service will be established to monitor and track the assets or collateral and, under a fee-for-service agreement, the collected information will be provided to the interested party.

If the monitoring/reporting device is not on-line and communication cannot be established (step 345=“NO”), then the previously collected historical information stored in collateral DB 223 of FIG. 1 may be provided to the user (step 360). Additionally, any other relevant information and/or extrapolations that may be pertinent and/or valuable in a collateral recovery process may also be provided. Specifically, the historical data contained in collateral DB 223 of FIG. 1 may be extracted and then used by predictive mechanism 225 of FIG. 2 to predict the most likely location or locations for the assets or collateral of interest. Depending on the specific business model and contractual relationship of the parties under consideration, this predictive location information may be provided to the user (step 370). Those skilled in the art will recognize that the specific information to be provided will depend on the specific application and the parties involved in the transaction. Accordingly, no assumptions or pre-conceived notions should be construed to limit the gathering and distribution of information according to the various preferred embodiments of the present invention.

Referring now to FIGS. 1-3, the overall process of implementing a collateral recovery program can be explained. In the context of an overall business process, the present invention can be used to establish a service for assisting all participants in the collateral recovery process. Initially, a service provider will utilize computer-based system 100 to establish an Internet-based Application Service Provider (ASP) “fee-for-service” model for monitoring, tracking, and reporting on the location and status of collateral via web server 222. The ASP website generated by computer-based system 100 will allow access to collateral database 223 from virtually any place in the world at practically any time. The owner/operator of computer-based system 100 will typically employ sales agents to offer subscriptions to potential customers so that they can benefit from the information gathered and made available by computer=based system 100. Additionally, in certain circumstances, lien holders and/or lenders may be provided with direct access to the information gathered and maintained by computer-based system 100 to utilize in certain collateral recovery efforts.

To take advantage of the ASP collateral service, a lien holder will pay a fee and then utilize computer system 170 to register at the website and provide the necessary information to customer database 224 do business with the ASP service provider. Then, when a purchaser subsequently initiates a purchase or lease and finances the purchase or lease, the lien holder can utilize computer system 170 to register the collateral used to secure the loan with collateral database 223 in computer-based system 100. In the most preferred embodiments of the present invention, the fee paid to register the collateral and monitor/track the location and status of vehicle 195 will be a single all-inclusive based on the length of the financing agreement for purchasing or leasing the collateral. The ASP service provider will then install the monitoring/reporting equipment or make arrangements to have the monitoring/reporting equipment installed in the collateral.

Once the collateral information has been entered into collateral database 223 and installation has been completed, the monitoring/reporting device associated with the collateral (for this example, vehicle 195) will be activated and begin providing periodic location and status information to collateral database 223 by utilizing the communication infrastructure of computer-based system 100 (i.e., network 120, satellite transceiver 145, satellite 155, and communication tower 190). As previously explained, the location of vehicle 195 can be determined by utilizing the GPS system and the location and status of vehicle 195 can be reported to data server 180 via standard cellular telephone technology.

In the future, if and when necessary, the can utilize computer system 170 to access collateral database 180, predictive mechanism 225, and report mechanism 226 to receive location and status information about vehicle 195. Predictive mechanism 225 will utilize the collateral information stored in collateral database 180 to forecast possible locations and times when vehicle 195 might be repossessed. In order to receive the location and status information, an additional fee may be required. The collateral information may be provided via various components of computer-based system 100 such as computer system 170, report mechanism 226, fax server 227, and/or e-mail server 228. If the information is sensitive, security mechanism 229 may be employed to encrypt and secure the information, as desired. As previously explained, even if the monitoring/reporting mechanism associated with vehicle 195 becomes damaged or inoperative, the information stored in collateral database 180 prior to the damage may be used to forecast the location of vehicle 195. Additionally, in certain preferred embodiments of the present invention, a “kill switch” may be installed in vehicle 195 and used to selectively disable vehicle 195, if necessary.

While the discussion of the most preferred embodiments has focused on the application of the present invention to the specific field of collateral recovery, those skilled in the art will recognize that other applications of the present invention are also possible. For example, one preferred embodiment of the present invention may be used to track and report on the status of vehicles for a fleet manager. In this embodiment, the historical time and location information gathered for the various fleet vehicles may be stored in a database and used to provide a series of operational and vehicle activity reports for the fleet manager. One such report may be a miles traveled report. This report would use the historical location information stored in the database to estimate or calculate the distance traveled by each vehicle in the fleet. Using this information, the fleet manager could schedule preventive maintenance and determine the appropriate time for replacing the fleet vehicles.

Yet another embodiment of the present invention may be utilized to provide a way to track and monitor heavy equipment at a job site. The owner of the heavy equipment could use the historical time and location data provided by the present invention to determine equipment usage patterns and optimization plans for deploying the heavy equipment. Other similar uses will be obvious to those skilled in the art.

In summary, the present invention provides an apparatus and method for the broad application of a unique business process for locating and recovering collateral where various entities including lender, lien holders, insurance companies, brokers, attorneys and the like are all benefited and served by the methods and integrated processes comprehended by the various preferred embodiments of the present invention. Lastly, it should be appreciated that the illustrated embodiments are preferred exemplary embodiments only, and are not intended to limit the scope, applicability, or configuration of the present invention in any way. Rather, the foregoing detailed description provides those skilled in the art with a convenient road map for implementing the preferred exemplary embodiments of the present invention. Accordingly, it should be understood that various changes may be made in the function and arrangement of elements described in the various preferred exemplary embodiments without departing from the spirit and scope of the present invention as set forth in the appended claims.

1. An apparatus comprising:
at least one processor;
a memory coupled to said at least one processor;
a database residing in said memory; and
a predictive mechanism residing in said memory, said predictive mechanism extracting previously stored historical information from said database and using said historical information to predict the location of at least one item being used for collateral.

2. The apparatus of claim 1 wherein said database comprises:
a collateral database, said collateral database comprising a plurality of records describing a plurality of items used as collateral to secure a plurality of loans; and
a customer database, said customer database comprising a plurality of records describing a plurality of customers for said plurality of items used as collateral to secure a plurality of loans.

3. The apparatus of claim 1 further comprising a fax server mechanism residing in said memory.

4. The apparatus of claim 1 wherein said item comprises a four-wheeled vehicle.

5. The apparatus of claim 1 further comprising an e-mail server residing in said memory, said e-mail server transmitting at least one e-mail message containing information extracted from said database.

6. The apparatus of claim 1 further comprising a network coupled to said at least one processor.

7. The apparatus of claim 1 further comprising at least one wireless communication device, said at least one wireless communication device transmitting location information to said database.

8. The apparatus of claim 1 further comprising a user interface, said user interface providing access to said historical information in said database, said user interface providing a plurality of reports regarding said at least one item being used for collateral.

9. An apparatus comprising:
at least one processor;
a network coupled to said at least one processor;
a memory coupled to said at least one processor;
a collateral database residing in said memory, said collateral database comprising a plurality of records describing a plurality of items used as collateral to secure a plurality of loans; and
a customer database residing in said memory, said customer database describing a plurality of customers for said plurality of items used as collateral to secure a plurality of loans.
at least one wireless communication device in communication with said network, said at least one wireless communication device communicating historical information regarding said plurality of items used as collateral to secure a plurality of loans to said collateral database via said network; and
a predictive mechanism residing in said memory, said predictive mechanism extracting historical information from said database and using said historical information to predict the location of said at least one vehicle being used for collateral; and
a user interface, said user interface providing access to said a plurality of records describing a plurality of items used as collateral to secure a plurality of loans, said user interface providing a plurality of reports regarding said a plurality of records describing a plurality of items used as collateral to secure a plurality of loans.

10. A method comprising the steps of:
monitoring an asset, said asset being used as collateral to secure a loan or a lease;
periodically storing data relative to said asset in a database;
accessing said data and using said data to predict the most probable physical location for said asset.

11. The method of claim 10 further comprising the step of using said data to recover said asset.

12. The method of claim 10 wherein said step of monitoring said asset comprises the steps of:
affixing at least one monitoring device to said asset; and
receiving data from said at least one monitoring device via at least one wireless communication device.

13. The method of claim 10 wherein said step of periodically storing data relative to said asset in said database comprises the step of using at least one wireless communication device to store location, condition, and status information relative to said asset in said database at least 4 times an hour.

14. The method of claim 10 wherein said step of accessing said data and using said data to predict the location of said asset comprises the step of accessing said database via a graphical user interface and retrieving at least a portion of said plurality of data.

15. The method of claim 14 further comprising the step of reporting said at least a portion of said plurality of data via a global computer network.

16. A program product comprising:
a predictive mechanism, said predictive mechanism being configured to extract previously stored historical information from a database, said predictive mechanism being configured to process said historical information to predict the location of at least one item being used for collateral; and
signal bearing media bearing said predictive mechanism.

17. The program product of claim 16 wherein said signal bearing media comprises recordable media.

18. The program product of claim 16 wherein said signal bearing media comprises transmission media.

19. The program product of claim 16 wherein said predictive mechanism is configured to communicate with at least one wireless communication device to store location, condition, and status information relative to said asset in said database at least 4 times an hour.

20. The program product of claim 16 further comprising a web server, said web server being configured to provide a graphical user interface to access said historical information.
